(19) United States
(12) Patent Application Publication
(10) Pub. No.: US 2021/0192093 A1
(43) Pub. Date: Jun. 24, 2021

(54) MODULAR SYSTEM FOR INTERCONNECTING VEHICLE SERVICES

(71) Applicant: Advanced Automotive Antennas, S.L.U., Barcelona (ES)

(72) Inventor: Francisco Javier PAREDES VERA, Barcelona (ES)

(73) Assignee: Advanced Automotive Antennas, S.L.U., Barcelona (ES)

(21) Appl. No.: 17/126,549

(22) Filed: Dec. 18, 2020

(30) Foreign Application Priority Data
Dec. 18, 2019 (EP) 19383136.9

(51) Int. Cl. G06F 21/85; G06F 13/362

(52) U.S. Cl. CPC G06F 21/85; G06F 13/362

(57) ABSTRACT

Modular systems for interconnecting different electric and/or electronic modules in a vehicle are described. The system includes a mother board that in turn includes a power connector and a data connector for connecting the mother board to a data bus of a vehicle, and two or more vehicle service connectors of the same type, for connecting different vehicle service modules to the mother board. The system also includes a processor that operates as the system controller to identify whether a vehicle service module connected to the mother board is authorized or not to be connected with the mother board, and to register the identity of the authorized vehicle services modules. The authorized vehicle services modules connected to the vehicle service connectors, once they have been registered into the system, they can communicate between them directly and independently from the processor.

### CROSS-REFERENCE TO RELATED APPLICATIONS

This application claims foreign priority benefits under 35 U.S.C. § 119(a)-(d) to EP 19383136.9 filed Dec. 18, 2019, the disclosure of which is hereby incorporated by reference in its entirety.

### TECHNICAL FIELD

The present invention refers in general to systems for interconnecting different electric and/or electronic service modules in a vehicle.

An object of the invention is to provide an interconnection system that congregate vehicle services at one location inside a vehicle, and that unifies main power supplies and protections at the same location.

An additional object of the invention is to provide a system for interconnecting vehicle services, incorporating an efficient power supply.

### BACKGROUND

Typically in a vehicle, power source is required to be appropriately supplied to a large number of services and electric components from a main power source like a battery, which is charged by an alternator.

Vehicles incorporate a plurality of control units for controlling electric devices, such that the control units and the associated device are connected and communicated with each other via wire harness.

There is an increasing demand to incorporate all kinds of technologies and devices available in the consumers markets into a vehicle, like communication systems, display devices etc. However, it is a challenge to integrate all those systems and services in the development phases of current vehicles or during their life cycle.

Currently, all technologies and services in-vehicle are distributed all over a vehicle, and connected between them with large and expensive data busses and wire hardness.

Therefore, the current approach generates a large number of disadvantages, like:
dissemination of devices all over the vehicle,
large wire harness to interconnect the different devices routed through the vehicle,
redundancy of components, like individual and different power supply, control units and electric protections for each service,
lack of standardization of connections, casing and fixation means.

The above-listed disadvantages of current techniques, increase complexity of assembly process, increase weight and vehicle manufacturing costs.

### SUMMARY

The present disclosure is defined in the attached independent claim, and it refers to a modular system for interconnecting vehicle services, that bring together vehicle services at one location inside a vehicle, and that unifies main power supplies and protections for most of the services.

Therefore, an aspect of the disclosure refers to a modular system for interconnecting vehicle services, wherein the system comprises a mother board acting as host module of the system. The mother board comprises: a power connector configured for connecting the mother board to a power source of a vehicle, and a data connector configured for connecting the mother board to a data bus of the vehicle to exchange data with the vehicle.

Additionally, the mother board comprises two or more vehicle service connectors of at least one type, that is, of the same standard (same dimension and configuration), for connecting different vehicle service modules to the mother board, so that a plurality of vehicle service modules can be connected indistinctly to any of the vehicle service connectors.

Examples of services to which the system applies are: GNSS position, V2X communication, Telematic services, WiFi in vehicle, Radio tuner, Remote Key Entry (RKE), emergency call (eCall), among others.

The mother board further comprises a data bus interconnecting the vehicle service connectors. The system further comprises at least one processor adapted to operate as the system controller to identify whether a vehicle service module connected to the mother board is authorized or not to be connected with the mother board, and to register the identity of those services that are authorized to be connected to the mother board and to operate as part of the system. Preferably, the mother board has a processor.

The processor acting as controller is the processor of the mother board, or the processor of a service module, or an external processor.

According to the invention, the system is adapted such that the authorized vehicle services modules connected to the vehicle service connectors, once they have been registered into the system, they can communicate between them directly and independently from the processor (without participation of the processor, that is, the processor does not manage the communication or simply it is turned-off).

The processor acting as the system controller in order to identify any vehicle services module connected to the mother board, is adapted in a way that if the connected vehicle service module is not authorized to be connected to the mother board, the processor disable power supply to the unauthorized vehicles service module, and to enable power supply to the connected vehicle service module when it is authorized.

The processor is communicated with the data bus of the mother board. The processor is adapted (it is programmed) to register an authorized service connected to the mother board in a way that when a vehicle service module connected to the mother board is authorized, the processor supplies to the data bus identification data related to the identity of an authorized vehicle service module connected to the mother board.

The system may be configured to turn-on the processor only when a vehicle service module is connected to the mother board, and once the processor has completed an identification and registration process to identify a vehicle service module connected to the mother board, the system may be configured to turn-off the processor, thus, the processor would be only operative during the identification and registration process.

Once an authorized vehicle service module have been registered into the system, the registered vehicle services modules can communicate with each other via the data bus of the mother board, while the processor could be turned-off.

In a preferred embodiment, the system includes at least one service module indistinctly connectable with any one of the vehicle service connectors of the mother board. Each of these service modules may have a processor, a communication device, and it has stored an unique identification code that serves to identify each specific service module from the others connected to the mother board. The service modules might be provided with a power supply unit or alternatively can receive power from the mother board.

The controller of the system does not need to be always located in the mother board. For example, the controller function can be carried out by a processor of an authorized service module registered with the mother board. This alternative is preferred for example in case that the computing capacity of the processor of a service module, is enough to use some of its computing capacity to act as “main controller” of the system.

For instance, a Telematic service has a powerful processor to operate himself but it capacity is not used at 100%. In this case, according to an embodiment, the remaining processing capacity may be used to act as a system controller, to identify new services as RKE (Remote Keyless Entry system), and in that case, the processor of the mother board would be disabled.

Therefore, the system is also adapted such that a service processor of an authorized service module when it is connected to the mother board, can act both as a system controller and as service module controller, and to disable the processor of the mother board. Optionally, the mother board has no processor, and a processor of a service module or a processor external to the mother board would act as system controller.

Then, when the service processor acting as controller, can perform the same functions of the mother board controller, that is, the identification and registration processes to authorize and register other services modules connected to the mother board.

In addition, when the system controller could be an external processor adapted to act as system controller to authorize and register other services modules connected to the mother board. In this case, the system is adapted to disable the processor of the mother board, or disable a processor of a service module that is acting as a system controller. Optionally, the mother board has no processor.

The alternative of using an external controller might be preferred for example during the manufacturing process of a vehicle at the time of adding services, or at any other time during the vehicles life to add new services.

When a vehicle manufacturer needs to incorporate new services into the vehicles, it is very convenient to use an external controller to manages the authorization and registration of the added services, and once all the services are connected the external controller is disconnected.

### BRIEF DESCRIPTION OF THE DRAWINGS

Embodiments of the invention are henceforth described with reference to the accompanying drawings, wherein:

FIG. 1 shows a schematic representation of the modular interconnection system of one embodiment.

FIG. 2 shows a more detailed schematic representation of the modular interconnection system of one embodiment.

FIG. 3 shows a block diagram of the internal components of service module.

FIG. 4 shows a flow chart illustrating the identification and registration process carried out by the main processor.

### DETAILED DESCRIPTION

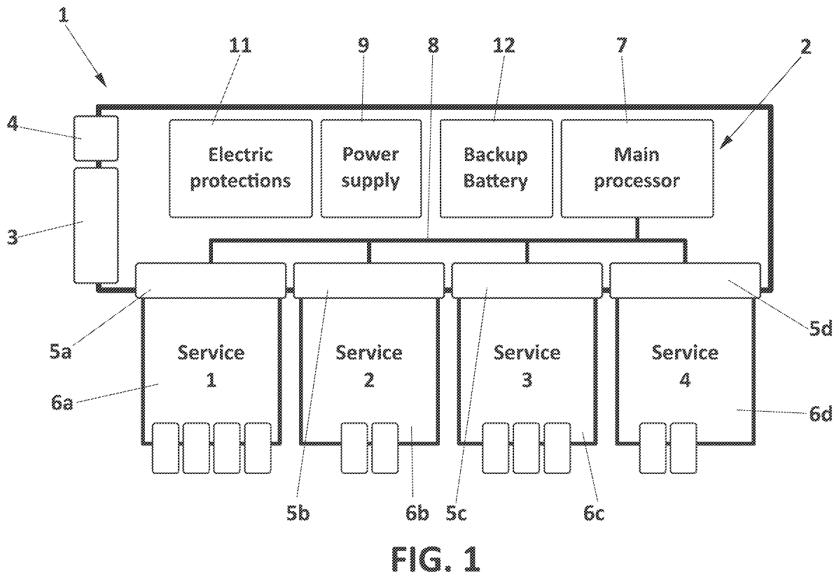

FIG. 1 shows a schematic representation of the modular interconnection system (1) of one embodiment, that comprises a mother board (2) in turn comprising a power connector (3) configured for connecting the mother board (2) to a power source of a vehicle, and a data connector (4) configured for connecting the mother board (1) to a data bus of the vehicle.

In this example, the mother board (2) additionally includes four service connectors (5a,5b,5c,5d) of the same type (same standard, same dimension and configuration), for connecting up to four or more different vehicle service modules (6a,6b,6c,6d) to the mother board (2), the service modules (6a,6b,6c,6d) having connectors compatible with the service connectors (5a,5b,5c,5d), so that any of the vehicle service modules (6a,6b,6c,6d) can indistinctly be connected to any of the connectors (5a,5b,5c,5d).

The mother board (1) additionally includes a data bus (8) interconnecting all the vehicle service connectors (5a,5b,5c,5d), and a processor (7) adapted to operate as the system controller, and communicated with the data bus (8) as to control the flow of data through it.

In the example shown in FIG. 1, the mother board (2) is a Printed Circuit Board (PCB) having a rectangular configuration, and wherein the vehicle services connectors (5a,5b,5c,5d) are mounted on one of the large sides of the PCB, whereas the power connector (3) and the data bus (8) are mounted in a short side of the PCB.

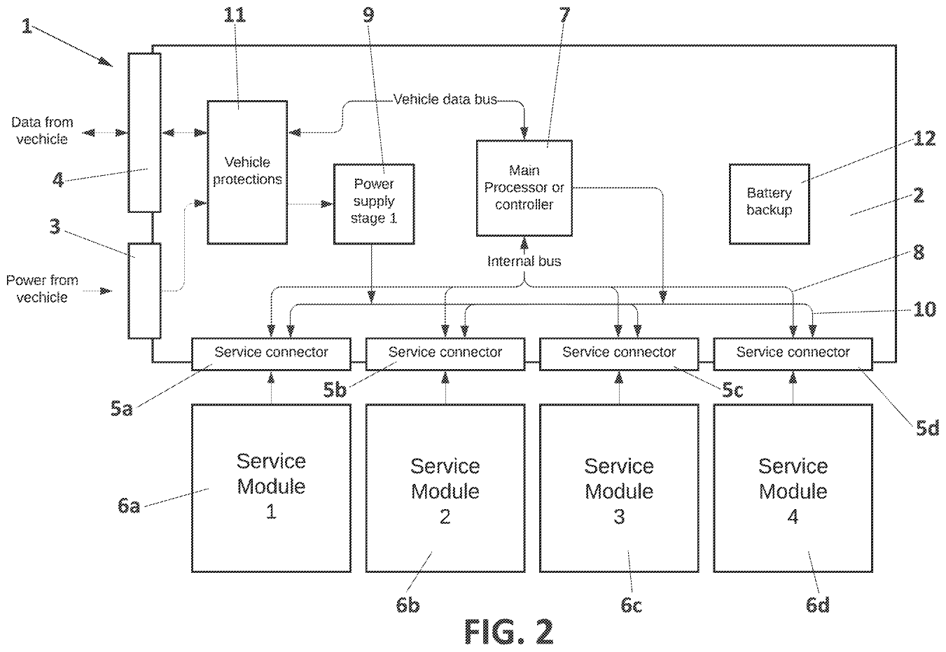

The architecture of the mother board (2) is shown in FIG. 2 in more detail. The mother board (2) has a power supply device (9), connected with the power connector (3) for receiving power from a vehicle, and to convert this power to a suitable power to feed all services modules (6a,6b,6c,6d) connected to the connectors (5a,5b,5c,5d) through an electric conductor (10), thus, all the service modules are fed with the same voltage and current.

The mother board (2) incorporates vehicle electrical protection means (11) connected to the power connector (3) and to the data connector (4), and wherein the power supply device (9) is connected to the power connector (3) through the vehicle protection means (11).

Furthermore, the processor (7) of the mother board (2) is also connected to the data connector (4) through the vehicle protection means (11).

A non-limiting list of protection means that are used are: Fuses, Transient Voltage Supresors (TVS), ESD protections and Over Voltage Supressor (MOV).

As shown in FIG. 2, the processor (7) is connected and adapted to enable and disable power supply from the power connector (3) to the vehicle services connectors (5a,5b,5c,5d), and also to the service modules (6a,6b,6c,6d) connected thereto.

A backup battery (12) is also provided in the mother board (2) or as external battery connected to the mother board, as to supply power in case of failure of the main power supply from the vehicle.

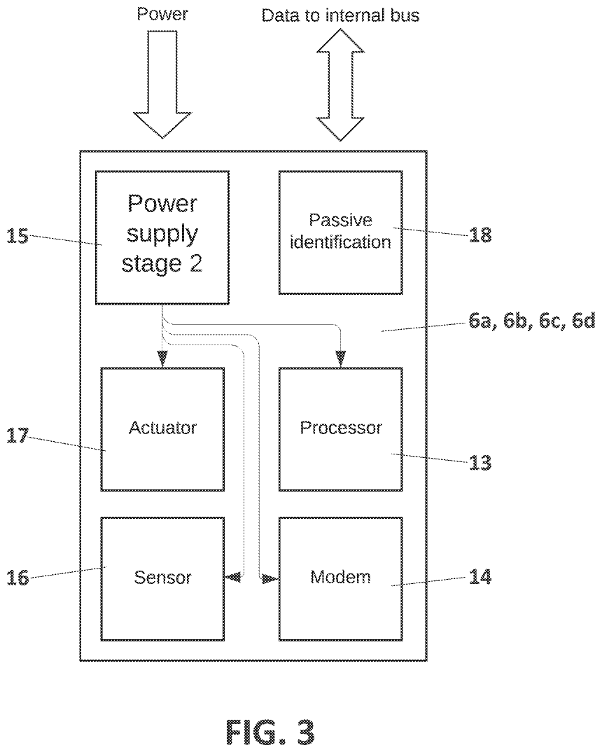

The architecture of each service module (6a,6b,6c,6d) is shown in FIG. 3, and may include a service processor (13), a communication device (14) for example a modem, and a power supply unit (15) that would receive power from the mother board (2). Preferably, each service module has stored a unique identification code for its identification when connected to the mother board.

Preferably, each service module (6a,6b,6c,6d) also may have a sensor (16), an actuator (17), and passive identification means (18).

The passive identification means (18) consist of a group of resistors that are connected in parallel with a voltage divisor in the mother board (2), that configure a unique combination and consequently an identification of each particular service module.

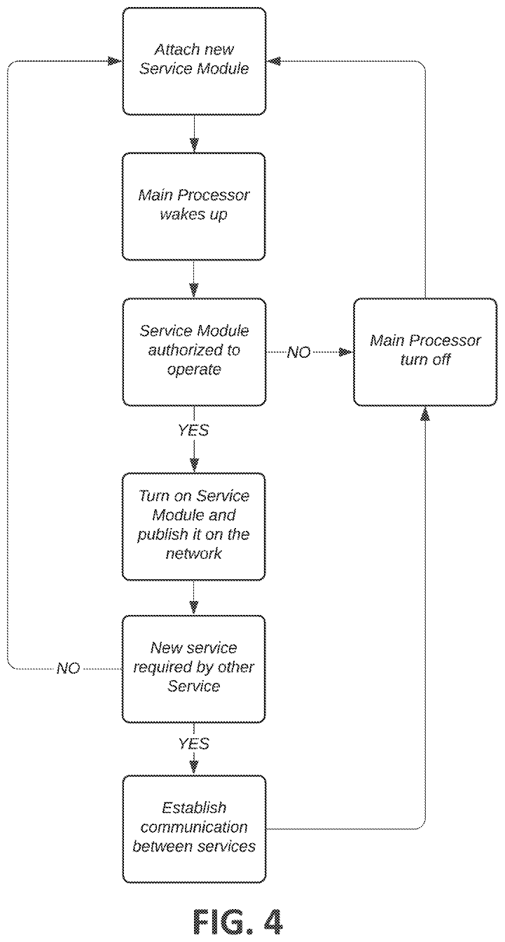

The identification and registration process carried out in the system (1) for identifying and registering service modules connected to the mother board (2), is shown in FIG. 4. The process follows this sequence:

1.—when a service module (6a,6b,6c,6d) is physically connected to a connector of the mother board (2), the mother board processor (7) wakes up;

2.—before turning-on the service module, a passive identification is performed as explained above (without the need of receiving power) by the processor of the mother board;

3.—if the connected service module is authorized, the processor of the mother board turns-on the service module,

4.—at the same time, the processor upload data relative to the new service to the other service modules using the data bus,

5.—when the previously registered service modules identify the new data upload, decide whether they are interested or not in the new service, if yes an acknowledge is send to the data bus. If not, the service module do nothing.

6.—the mother board processor may go to sleep (it is turned-off).

For instance, if a service module of Telematics has a service to track and send to an external server the position of the vehicle each minute, when a new GNSS position service is available in the data bus (8), the Telematic service decide that the information of the GNSS position service is useful for their functionality and starts the communication with it. At the same time, GNSS position service isn't useful for the RKE service, so the RKE decide to discard that information.

The system (1) is adapted such that when a vehicle service module connected to the mother board (2) is not authorized to operate in the system, the processor (7) disables power supply to the unauthorized vehicles service module.

The system (1) is adapted to enable power supply to the authorized services, so that once the authorized services have been registered into the system, they can communicate between them directly and independently from the processor, which may be turned-off while no identification and registration process has to be carried out.

Additional features of a preferred implementation are:
The controller could upload data relative to the identification of the different Services to the Data bus of the vehicle,
The main processor could upload data relative to the identification of the different Services to the data bus of the mother board,
The controller could be added as a first Service (then during the process, is the first stage)
The controller could modify and filter the Services signals before sending to the Data bus of the vehicle, and vice-a-versa, could modify or filter the data received from the Data bus of the vehicle
The internal bus could be a ring, star, Daisy chain, etc. topology
The mother board may have a DC/DC converter to an intermediate voltage (i.e. from 12V, vehicle battery, to a 5V) and if needed each service would convert this standard voltage to its necessity (to make the more powerful conversion in only one place and give to all the services the same voltage to maintain the interchangeability)
A preferred location in a vehicle to install the entire system is the roof of the vehicle, but trunk and pillars are also preferred.

Other preferred embodiments of the present invention are described in the appended dependent claims and the multiple combinations of those claims.

What is claimed is:

1. A modular system for interconnecting vehicle services, the system comprising:
a mother board including a power connector configured to connect to a power source of a vehicle, and a data connector configured to connect to a data bus of the vehicle, and a plurality of vehicle services connectors, each configured to connect to a different one of a plurality of vehicle services modules;
the mother board further including a data bus interconnecting the vehicle services connectors; and
at least one processor programmed to:
identify whether one of the vehicle services modules connected to the mother board via one of the services connectors is authorized to be connected with the mother board,
register the identity of an authorized vehicle services module connected to the mother board, and
authorize communication between the authorized vehicle services module via the data bus in response to the authorized vehicle services module being registered.

2. The system of claim 1, wherein the processor is connected and programmed to enable and unable power supply from the power connector to the vehicle services connectors.

3. The system of claim 1, wherein the processor is programmed to disable the power source to any unauthorized vehicle services modules, and to enable the power source to any authorized vehicle services modules.

4. The system of claim 1, wherein the processor is further programmed to transmit data bus identification data related to the identity of the authorized vehicle services module connected to the mother board in response to the authorized vehicle services module being connected to the mother board in order to register the authorized services module.

5. The system of claim 1, wherein the processor is further programmed to turn-off after the authorized vehicle services module is identified, and turn-on when a new vehicle services module is connected to the mother board so that the processor is only operative during the identification process.

6. The system of claim 1, wherein the processor is further programmed to open communication between the registered vehicle services modules via the data bus once the authorized vehicle services module connected to the mother board have been registered.

7. The system of claim 1, wherein the at least one services module is indistinctly connectable with any one of the vehicle services connectors of the mother board, and wherein the at least one services module has at least one of a processor, a communication device, and a power supply unit, and wherein the at least one vehicle services module has stored a unique identification code.

8. The system of claim 1, further comprising a service processor associated with the at least one authorized services module connected to the mother board and configured to act as a system controller, the service processor configured to authorize and register other services modules connected to the mother board.

9. The system of claim 1, wherein the processor is further programmed to allow an external processor to act as system controller to authorize and register other services modules connected to the mother board.

10. The system of claim 1, wherein the mother board includes a power supply device connected with the power connector for receiving power from a vehicle, and also connected with the vehicle service connectors for supplying power to the at least one vehicle services module connected to the mother board.

11. The system of claim 10, wherein the mother board incorporates vehicle electrical protection mechanism connected to at least one of the power connector or to the data connector.

12. The system of claim 11, wherein the power supply device is connected to the power connector through the vehicle protection mechanism.

13. The system of claim 11, wherein the processor of the mother board is connected to the data connector through the vehicle protection mechanism.

14. The system of claim 1, wherein the service modules are at least one of the following services: GNSS positioning, V2X communication, Telematic services, WiFi in vehicle, Radio tuner, Remote Key Entry (RKE), and emergency call (eCall).

15. The system of claim 1, further comprising a backup battery, the backup battery is provided in the mother board or is an external battery connected to the mother board.

16. A method for interconnecting vehicle services of a modular system, comprising:
identify whether any vehicle services systems connected to a mother board via one of a plurality of service connectors is authorized to be connected with a mother board,
register the identity of each authorized vehicle services system connected to the mother board, and
authorize communication between the authorized vehicle services systems via a data bus in response to the authorized vehicle services systems being registered.

17. The method of claim 16, further comprising disabling power supply to any unauthorized vehicle services systems.

18. The method of claim 16, further comprising enabling power supply to any authorized vehicle services systems.

19. The method of claim 16, further comprising transmitting data bus identification data related to the identity of the authorized vehicle services systems connected to the mother board in response to the authorized vehicle services systems being connected to the mother board in order to register the authorized service systems.

20. The method of claim 16, further comprising enabling communication between the registered vehicle services systems via the data bus once the authorized vehicle services systems connected to the mother board have been registered.
